(19) United States
(12) Patent Application Publication
(10) Pub. No.: US 2003/0188045 A1
(43) Pub. Date: Oct. 2, 2003

(54) System and method for distributing storage controller tasks

(76) Inventor: Michael B. Jacobson, Boise, ID (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 09/548,687

(22) Filed: Apr. 13, 2000

(51) Int. Cl. G06F 3/00; G06F 12/16

(52) U.S. Cl. 710/1; 711/114

(57) ABSTRACT

A data access task distributor receives a request to perform a data access task. The request is received by a first processor, which identifies an appropriate processor to process the request. The first processor processes the request if the first processor is the appropriate processor to process the request. The first processor forwards the request to the appropriate processor if the first processor is not the appropriate processor to process the request. The first processor identifies the appropriate processor by retrieving data from a table that identifies the types of data access tasks handled by each processor.

### TECHNICAL FIELD

This invention relates to handling data access tasks. More particularly, the invention relates to systems and methods for distributing data access tasks between multiple processors.

### BACKGROUND

Computer systems typically utilize mass storage systems for storing program data, application programs, configuration data, and related information. A mass storage system includes one or more storage devices, such as disk drives, to store information. In certain computer systems, the storage devices are connected directly to the main computer system. However, it is advantageous to attach the storage devices to the main computer system through a separate storage controller. Using a separate storage controller relieves the main computer system from executing the various storage control tasks. Additionally, the use of a separate storage controller allows the optimization of the design of the storage controller for the particular storage control application. The main computer system is not typically optimized for a particular storage control application. An optimized storage controller can provide functions not available in the storage devices themselves. Additionally, an optimized storage controller can provide functions not available in a general purpose computer. For example, an optimized storage controller can provide for redundancy in the stored data, thereby increasing the likelihood of data availability. An optimized storage controller can also provide increased connectivity of storage devices to the main computer system by combining multiple device interface busses into a smaller number of bus interfaces to the main computer.

A storage controller contains one or more microprocessors and one or more data transmission paths. Each data access operation that is managed by a storage controller uses both microprocessor time to perform control functions and a portion of the data transmission bandwidth to transmit the data. Increasing the number of microprocessors or increasing the number of data transmission paths in a storage controller increases the overall performance of the storage controller.

In existing systems, multiple storage controllers are connected between the main computer system and the storage devices. In these existing systems, each storage controller is associated with, and responsible for the control of, a particular group of storage devices. Each storage controller is familiar with the status of its associated storage devices, but is not aware of the existence or status of other storage devices that are associated with other storage controllers. These systems are burdensome to the host because the host must determine (i.e., calculate) the appropriate storage controller to handle each data access request, and send the data access requests to the appropriate storage controller. The calculation of the appropriate storage controller requires processor resources that might otherwise be used for other processing operations.

Other existing systems use two storage controllers connected between the main computer system and the storage devices. In these systems, the first storage controller actively participates in the storage control function while the second storage controller remains idle. If the currently active storage controller fails, then the other storage controller becomes the active controller. This arrangement does not provide any mechanism for workload sharing between the two controllers because one controller is always idle. Furthermore, a failure in the idle storage controller is not typically detected until the active controller fails and the idle storage controller is needed.

Other systems that utilize two storage controllers designate one controller as the “primary” controller and the other controller as the “secondary” controller. The primary controller manages data communications with both the main computer system and the attached storage devices. The secondary controller manages data communications with the main computer system, but not with the storage devices. Data and control tasks associated with data access operations initiated on the secondary controller are communicated to the primary controller for execution. The primary controller processes all device storage operations that are initiated on both the primary controller and the secondary controller. This system results in the under-utilization of the secondary controller because the primary controller experiences a larger workload than the secondary controller.

Accordingly, there remains a need to balance workload tasks among multiple storage controllers or multiple processors to fully utilize the resources associated with each storage controller or processor.

### SUMMARY

The present invention concerns data storage systems that distribute data access tasks between multiple storage controllers or between multiple processors in a storage controller. The invention removes much of the data access processing from the host system and eliminates the need for the host system to communicate the data access request to the correct storage controller.

An embodiment of the invention provides a method of distributing data access tasks. A first processor receives a request to perform a data access task. The first processor identifies an appropriate processor to process the request. If the first processor is the appropriate processor to process the request, then the first processor processes the request. If the first processor is not the appropriate processor to process the request, then the first processor forwards the request to the appropriate processor.

### BRIEF DESCRIPTION OF THE DRAWINGS

FIG. 1 illustrates a data storage system including multiple redundancy groups and an aggregator module.

FIG. 2 illustrates an embodiment of a storage system using two storage controllers to access data from four redundancy groups.

FIG. 3 illustrates an example table that identifies the types of data access tasks handled by each processor in the storage controllers.

FIG. 4 illustrates a storage controller containing two processors for accessing data from four redundancy groups.

FIG. 5 is a flow diagram illustrating a procedure for handling a data access request from a host.

FIG. 6 illustrates an exemplary data striping procedure.

The same reference numbers are used throughout the figures to reference like components and features.

### DETAILED DESCRIPTION

The present invention relates to the distribution of data storage tasks among multiple storage controllers. Storage systems implemented using this invention enable the balancing of storage tasks among multiple storage controllers to better utilize the resources associated with each storage controller.

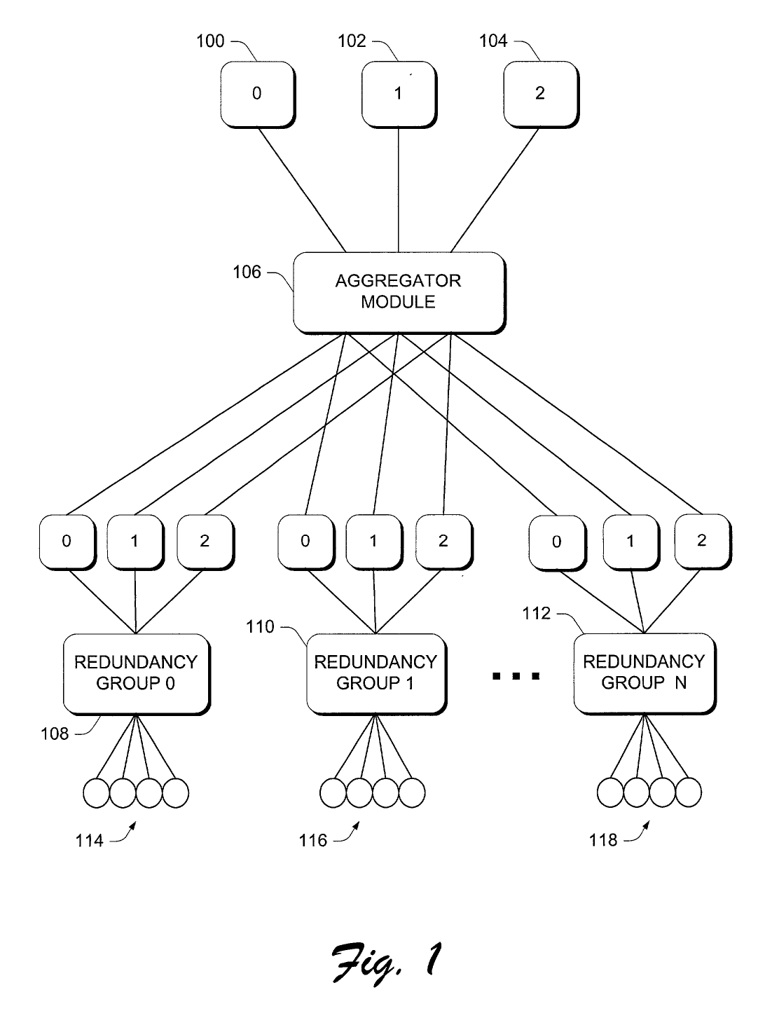

FIG. 1 illustrates a data storage system including multiple redundancy groups and an aggregator module. The data storage system has three virtual storage objects 100, 102, and 104. These virtual storage objects 100-104 are visible to the host system (e.g., a computer or other data processing device) and are referenced by the host system when storing or retrieving data from the data storage system. The virtual storage objects 100-104 may also be referred to as aggregated storage objects. The actual data associated with a particular virtual storage object 100-104 may be distributed across any or all of the multiple redundancy groups.

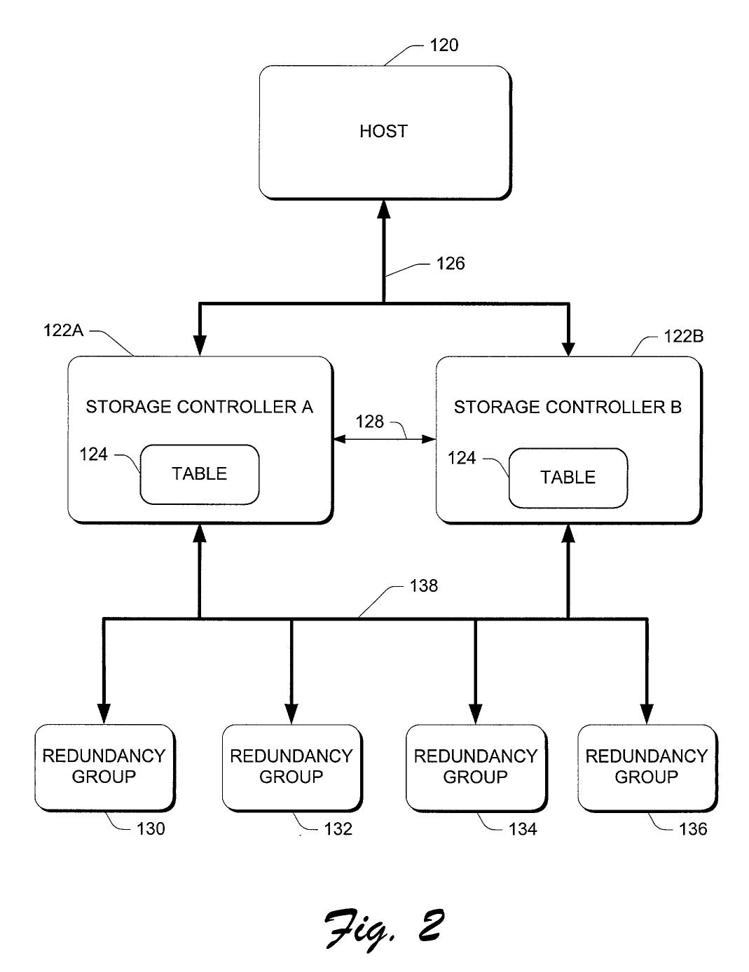

An aggregator module 106 is coupled to each of the three virtual storage objects 100, 102, and 104. The aggregator module 106 implements a process (using hardware and/or software components) that aggregates multiple redundant storage devices to generate the virtual storage objects 100, 102, and 104. An embodiment of aggregator module 106 contains two storage controllers, as described below with reference to FIG. 2. The processing operations performed by aggregator module 106 are distributed among the two storage controllers. The aggregator module 106 also distributes data across the multiple redundancy groups. In alternate embodiments, aggregator module 106 may contain any number of storage controllers that handle any number of virtual storage objects.

The data storage system of FIG. 1 includes multiple redundancy groups 108, 110, and 112. Each redundancy group is mapped to a particular storage controller in the aggregator module 106. Additionally, a set of three virtual storage spaces are coupled between the aggregator module 106 and each redundancy group 108-112. Each set of three virtual storage spaces is logically associated with the three virtual storage objects 100, 102, and 103.

Each redundancy group 108, 110, and 112 has an associated array of disk drives 114, 116, and 118, respectively. Disk drive arrays 114, 116, and 118 represent the physical disk storage space used to store data. The physical storage space provided in disk drive arrays 114, 116, and 118 is mapped to the set of three virtual storage spaces coupled between each redundancy group and the aggregator module 106. The present invention can be applied to data storage systems having any number of redundancy groups. Each redundancy group 108-112 is an instance of a raid (redundant array of inexpensive devices) storage device. Additional details regarding raid storage devices can be found in U.S. Pat. No. 5,392,244, the disclosure of which is incorporated herein by reference.

The aggregator module 106 and the multiple redundancy groups 108-112 are transparent to the host system seeking access to the storage system. The host system generates a data access request (e.g., a “read data” operation or a “write data” operation) and communicates the request to one of the virtual storage objects 100, 102, and 104. The host system's data access request identifies a particular virtual storage object on which the data read operation or write operation is to be performed.

After receiving the host's data access request, the aggregator module 106 and the redundancy groups 108-112 handle the actual storage or retrieval of data from the physical disk drives. Thus, a single virtual storage space is presented to the host, thereby eliminating the need for the host to perform the various storage control tasks. Those storage control tasks are handled by the aggregator module 106 and other components of the data storage system.

FIG. 2 illustrates an embodiment of a storage system using two storage controllers to access data from four redundancy groups. A host system 120 generates a request for a data access task (e.g., read data or write data) and communicates the request across communication link 126. Communication link 126 may be a bus or other communication medium capable of communicating signals between host 120 and two storage controllers 122A and 122B. Each storage controller 122A and 122B has a unique address, which allows the host to identify a particular storage controller for a particular data access task. Although a single communication link 126 is shown in FIG. 2, a separate communication link may be provided between the host and each storage controller.

A communication link 128 allows storage controllers 122A and 122B to communicate directly with one another. For example, data may flow across communication link 128 if forwarded to a different processor in a different controller. Data may continue to flow across link 128 after the new processor takes control of the data access task because the host may expect to receive the return data or acknowledgement from the originally addressed controller. Alternatively, the two storage controllers can communicate with one another across communication link 126 instead of or in addition to communication link 128.

Four redundancy groups 130, 132, 134, and 136 are coupled to the storage controllers 122A and 122B using communication link 138. The interface between the two storage controllers and the four redundancy groups may be implemented, for example, using SCSI (Small Computer System Interface) or the Fibre Channel Interface. Each redundancy group 130-136 contains one or more physical disk drives for storing data. As shown in FIG. 2, each storage controller 122A and 122B is coupled to all four redundancy groups 130-136, thereby allowing either storage controller to access data stored in any redundancy group.

Although a single communication link 138 is provided between the storage controllers 122A and 122B and the redundancy groups, alternate embodiments provide redundant communication links between the storage controllers and the redundancy groups. In this alternate embodiment, the disk drives contained in the redundancy groups are dual-ported. A first communication link (e.g. communication link 138) is coupled to a first port of the disk drives and a second communication link (not shown) is coupled to a second port of the disk drives.

Each storage controller 122A and 122B includes a table 124 that identifies the types of data access tasks handled by each storage controller or by each processor in the storage controllers. Table 124 may be stored in volatile or non-volatile memory within the storage controller. Each table 124 stores the same set of data. In a particular embodiment, each storage controller 122A and 122B includes two processors, each of which is primarily responsible for a different redundancy group. For example, the two processors in storage controller 122A are primarily responsible for redundancy groups 130 and 132, and the two processors in storage controller 122B are primarily responsible for redundancy groups 134 and 136.

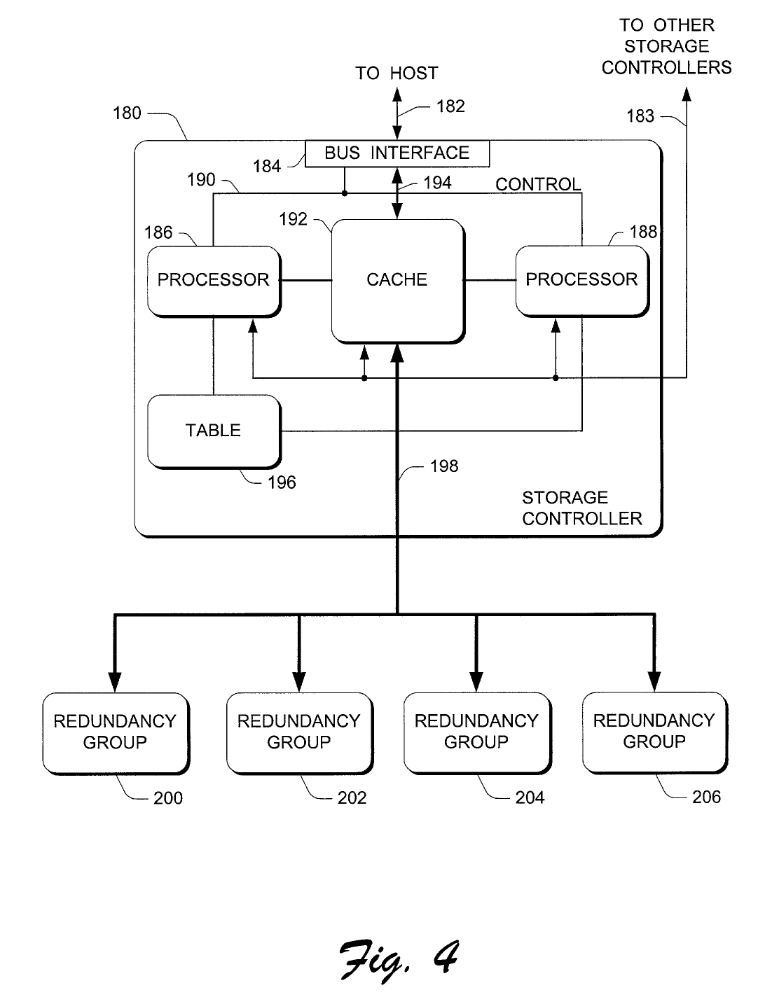

The configuration shown in FIG. 2 uses two different storage controllers 122A and 122B to handle the various data access requests received from host 120. This configuration distributes the data access workload between the two storage controllers such that the resources of both storage controllers (e.g., processors and cache memory discussed below with respect to FIG. 4) are used simultaneously. Thus, rather than using a master-slave relationship or a primary-backup relationship between the two storage controllers, FIG. 2 illustrates a peer-peer relationship in which both storage controllers share in processing the data access requests.

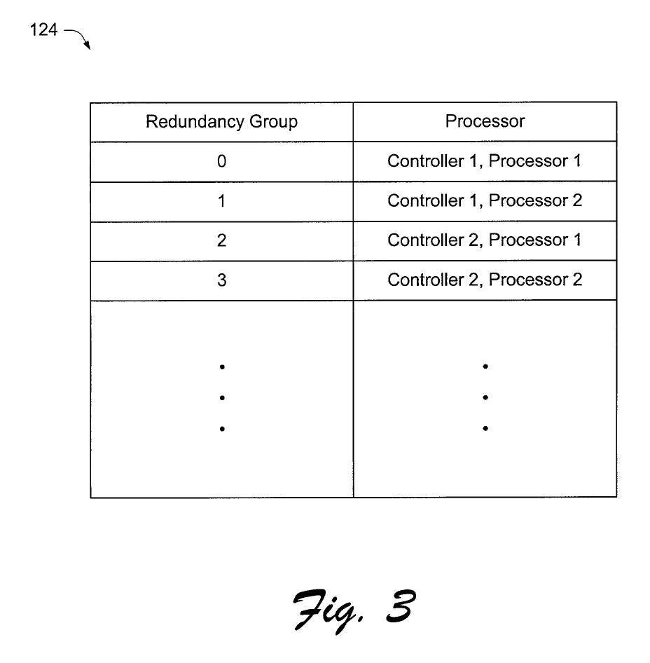

FIG. 3 illustrates an example table 124 that identifies the types of data access tasks handled by each processor in the storage controllers 122A and 122B. In table 124, the redundancy groups are numbered beginning with zero. Redundancy group 0 corresponds to group 130 in FIG. 2, redundancy group 1 corresponds to group 132 in FIG. 2, and so forth. As shown in FIG. 3, each redundancy group has an associated processor in one of the two controllers. In this example, each controller has two processors. Typically, the controllers and processors within the controllers will have unique identifiers (such as addresses) that indicate the controller and processor associated with each redundancy group in table 124.

Since each storage controller 122A and 122B (and each processor within the storage controllers) is familiar with the responsibilities of the other storage controller (and each processor is familiar with the responsibilities of the other processors), the communications between the two storage controllers is reduced. Although the embodiment of FIG. 2 includes two storage controllers and four redundancy groups, the teachings of the present invention can be applied to a data storage system having any number of storage controllers and any number of redundancy groups.

FIG. 4 illustrates a storage controller 180 containing two processors 186 and 188 for accessing data from four redundancy groups 200, 202, 204, and 206. Although storage controller 180 contains two processors, the teachings of the present invention can be applied to a storage controller having any number of processors. Further, different storage controllers in the same storage system may have a different number of processors.

A data access request is received from a host on a communication link 182. Additionally, data and other information can be received and transmitted on communication link 182. Another communication link 183 allows the exchange of data and other information between two or more storage controllers. In this example, communication link 183 is coupled to the processors 186 and 188 and the cache 192 of each storage controller. Communication link 183 corresponds to communication link 128 in FIG. 2.

A bus interface 184 provides an interface between communication link 182 and the storage controller 180. Bus interface 184 distributes control signals to processor 186 or 188 using a communication link 190. Data is communicated between bus interface 184 and a cache 192 using communication link 194. Each processor 186 and 188 is coupled to the cache 192 and a table 196. Table 196 is the same table as table 124 shown in FIG. 2 and identifies the types of data access tasks handled by each processor in the storage controller 180. Data flowing to or from the redundancy groups 200-206 passes through cache 192. A communication link 198 couples the cache 192 to the four redundancy groups 200-206.

The data flowing into and out of cache 192 is controlled by processor 186 and/or processor 188, depending on which processor is responsible for the particular redundancy group being accessed (as indicated by table 196). Although a single cache 192 is shown in FIG. 4, alternate embodiments include a separate cache for each processor. When processor 186 or 188 receives a data access request, the processor first identifies the appropriate processor to handle the request, based on information contained in table 196. If necessary, the processor forwards the request to the other processor for handling. If neither processor 186 nor 188 is the appropriate processor to handle the request, then the processor receiving the request identifies the appropriate processor using table 188 and forwards the request to the appropriate processor. In this example, the appropriate processor is located in a different storage controller. The information stored in table 196 may be loaded into cache 192 or the processors 186 and 188 to allow faster access to the data contained in the table.

In the example of FIG. 4, processor 186 is responsible for handling data access requests associated with redundancy groups 200 and 202. Processor 188 is responsible for data access requests associated with redundancy groups 204 and 206. Since each processor 186 and 188 is familiar with the responsibilities of the other processor (using the information contained in table 196), the communications between the two processors is reduced, thereby increasing the processing resources available for handling data access requests from a host system. In a particular embodiment of the invention, processors 184 and 186 are microcontrollers, such as an i960® microcontroller manufactured by Intel Corporation of Santa Clara, Calif. or a PowerPC 603E manufactured by Motorola, Inc. of Schaumburg, Ill.

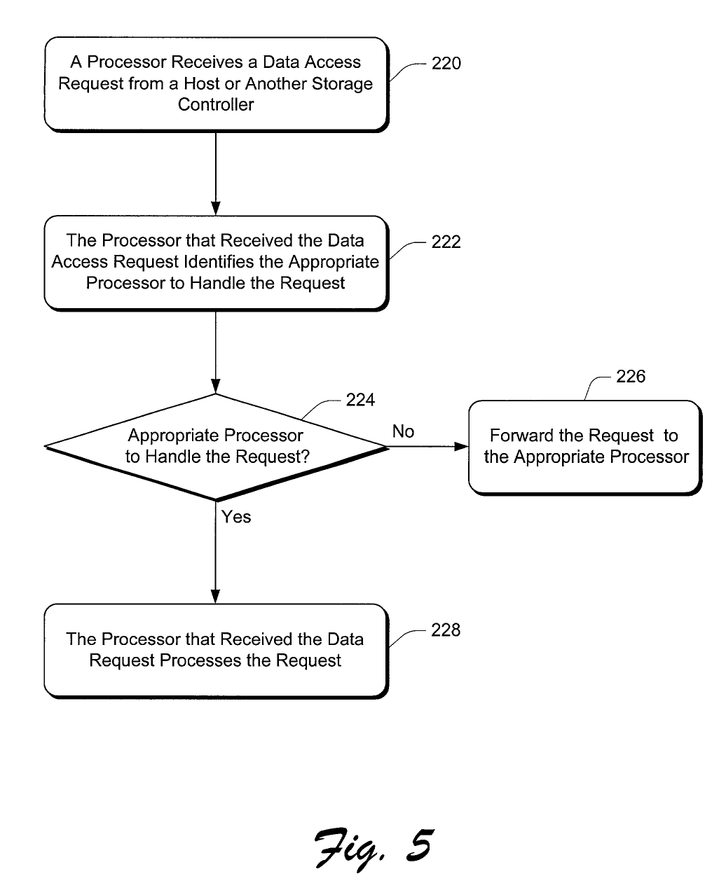

FIG. 5 is a flow diagram illustrating a procedure for handling a data access request from a host using the storage controller of the type shown in FIG. 4. Initially, a processor (e.g., processor 186 or 188 in FIG. 4) receives a data access request from a host system or another processor (block 220). The processor receiving the data access request identifies the appropriate processor to handle the request (block 222). This identification is performed, for example, by accessing information stored in table 196 (FIG. 4). If the processor determines that the appropriate processor to handle the request is not the processor that received the data access request (block 224), then the processor forwards the request to the appropriate processor (block 226). Otherwise, the processor that received the data access request processes the request (block 228). Thus, if a processor receives a data access request that should be handled by a different processor, the data access request is automatically forwarded to the appropriate processor without requiring any intervention by the host.

In one embodiment, sharing of the data access workload is accomplished using a dynamic workload distribution policy such as data striping between the redundancy groups. Data striping refers to the segmentation of a sequence of data (such as a single file) such that each segment is stored on a different storage device in a cyclical manner. This type of distribution policy evenly distributes the workload across the multiple redundancy groups, thereby distributing the data access tasks across the multiple processors.

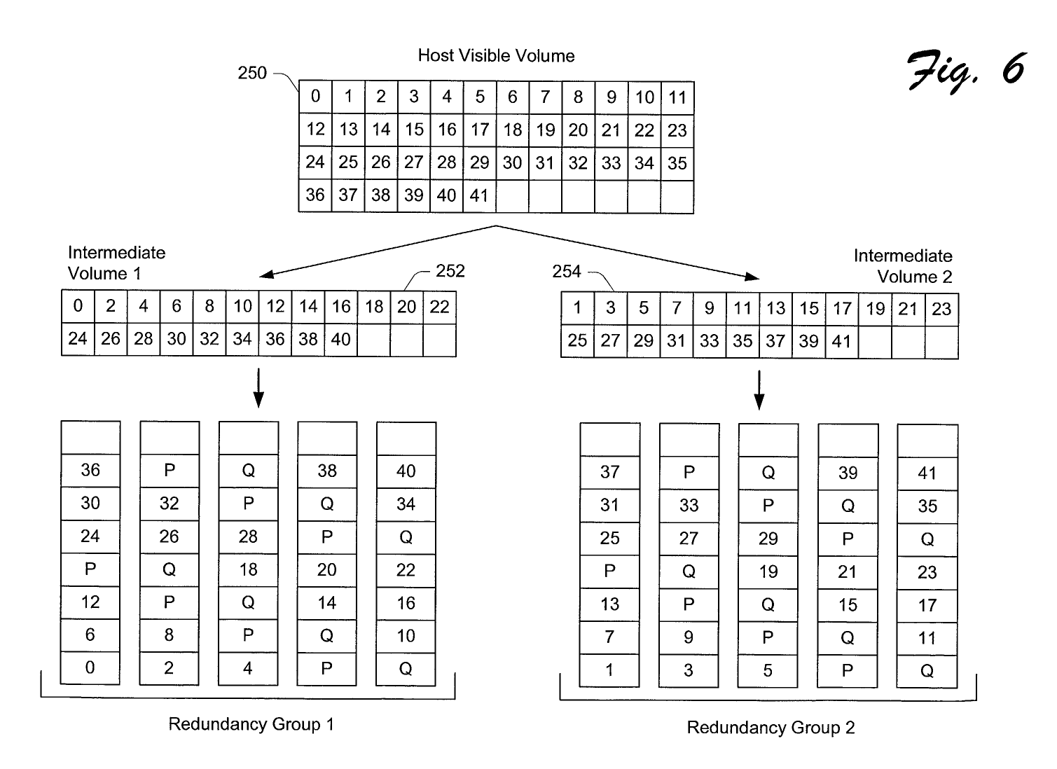

FIG. 6 illustrates an exemplary data striping procedure. A host seeking access to stored data sees a volume 250 containing, in this example, 42 blocks of data. In alternate embodiments, volume 250 may contain any number of data blocks. The data contained in volume 250 is stored in two different redundancy groups, where each redundancy group is an instance of a raid (redundant array of inexpensive devices) storage device. The data in volume 250 is separated into two intermediate volumes 252 and 254. Intermediate volume 252 includes the first, third, fifth, etc. blocks of data from volume 250, and intermediate volume 254 includes the second, fourth, sixth, etc. blocks of data from volume 250. The data contained in each intermediate volume 252, 254 is then “striped” across one of the redundancy groups.

In the example of FIG. 6, each redundancy group contains five storage devices. Each storage device is represented as a column in the redundancy group. A “stripe” is defined as a row (containing five entries—one for each storage device) in one of the redundancy groups. For example, in Redundancy Group 1, a particular stripe is “0 2 4 P Q”. The letters “P” and “Q” identify redundancy blocks, which store redundant copies of data. In this example, each stripe contains two blocks of redundancy. As illustrated, the redundancy blocks shift within the row from one stripe to the next. The actual storage location of the data is not known to the host. The host sees a single volume 250, but does not see the various redundancy groups that store the actual data.

When a data access request is received by a processor, the data striping process identifies the particular redundancy group associated with the data access request. The processor then determines which processor is associated with the identified redundancy group using information stored, for example, in table 124 (FIG. 2) or table 196 (FIG. 4). The processor associated with the identified redundancy group then processes the data access request.

Data striping between redundancy groups is one possible procedure for distributing the data access workload. Various other procedures can be used to distribute the data access workload among multiple processors.

The present invention is advantageous over prior art solutions in that it removes the task of workload distribution across the processors from the host system. In addition, the invention balances the data access workload between all processors in the data storage system. Each processor is aware of other processors in the data storage system as well as the redundancy groups associated with each of the other processors. Thus, a processor is able to forward a data access request to the appropriate processor for handling if it is not the appropriate processor to handle the requested data access task.

Although the invention has been described in language specific to structural features and/or methodological steps, it is to be understood that the invention defined in the appended claims is not necessarily limited to the specific features or steps described. Rather, the specific features and steps are disclosed as preferred forms of implementing the claimed invention.

1. A method of distributing data access tasks, the method comprising:
receiving a request to perform a data access task, wherein the request is received by a first processor;
the first processor identifying an appropriate processor to process the request;
the first processor processing the request if the first processor is the appropriate processor to process the request; and
the first processor forwarding the request to the appropriate processor if the first processor is not the appropriate processor to process the request.

2. A method as recited in claim 1, wherein identifying the appropriate processor comprises the first processor retrieving data from a table that identifies the types of data access tasks handled by each processor.

3. A method as recited in claim 1, wherein each processor processes a subset of all possible data access tasks.

4. A method as recited in claim 1, wherein the first processor is contained in a storage controller.

5. A method as recited in claim 4, wherein a table that identifies the types of data access tasks handled by each processor is contained in the storage controller.

6. A method as recited in claim 4, wherein the storage controller stores data on multiple storage devices using a data striping process.

7. A method as recited in claim 1, wherein the first processor is contained in a first storage controller and a second processor is contained in a second storage controller, and wherein data access tasks are distributed between the first and second storage controllers.

8. One or more computer-readable memories containing a computer program that is executable by a second processor to perform the method recited in claim 1.

9. A data storage system comprising:
a first array of storage devices;
a second array of storage devices;
a first processor coupled to the first array of storage devices, wherein the first processor processes data access tasks associated with the first array of storage devices; and
a second processor coupled to the first processor and coupled to the second array of storage devices, wherein the second processor processes data access tasks associated with the second array of storage devices, and wherein the second processor is aware of data access tasks processed by the first processor.

10. A data storage system as recited in claim 9, wherein the first processor is aware of data access tasks processed by the second processor.

11. A data storage system as recited in claim 9, wherein the first and second processors store data on the first and second arrays of storage devices using a data striping process.

12. A data storage system as recited in claim 9, wherein the first and second arrays of storage devices are redundant arrays of inexpensive devices.

13. A data storage system as recited in claim 9, wherein the second processor determines the appropriate processor to process a data access task based on knowledge of data access tasks processed by the first processor and knowledge of data access tasks processed by the second processor.

14. A data storage system as recited in claim 9, wherein the first and second processors are coupled to a host system to receive requests to perform data access tasks.

15. A data storage system as recited in claim 9, wherein the first processor is contained in a first storage controller and the second processor is contained in a second storage controller, and wherein data access tasks are distributed between the first and second storage controllers.

16. A method of distributing data access tasks to multiple redundancy groups, the method comprising:
receiving a request to perform a data access task from a host, wherein the host is unaware of the multiple redundancy groups, and wherein the request is received by a first processor;
the first processor identifying an appropriate processor to process the request based on data contained in a table indicating the types of transactions handled by a plurality of processors;
the first processor processing the request if the first processor is the appropriate processor to process the request; and
the first processor forwarding the request to an appropriate processor if the first processor is not the appropriate processor to process the request.

17. A method as recited in claim 16, wherein each processor processes a subset of all possible data access tasks.

18. A method as recited in claim 16, wherein each processor is associated with at least one redundancy group.

19. A method as recited in claim 16, wherein the first processor stores data on a storage device using a data striping process.

20. A method as recited in claim 16, wherein each redundancy group is a redundant array of inexpensive devices.
